(19) United States
(12) Patent Application Publication
(10) Pub. No.: US 2026/0226581 A1
(43) Pub. Date: Aug. 6, 2026

(54) METHOD FOR LEACHING GOLD FROM A GOLD-BEARING SUBSTRATE

(71) Applicants: UNIVERSITÉ LIBRE DE BRUXELLES, Bruxelles (BE); UNIVERSITÉ NORBERT ZONGO, Koudougou (BF)

(72) Inventors: Thomas Doneux, Bruxelles (BE); Moussa Bougouma, Koudougou (BF); Fousseni Soma, Koudougou (BF); Claudine Herman, Bruxelles (BE)

(21) Appl. No.: 19/153,935

(22) PCT Filed: Feb. 14, 2024
(86) PCT No.: PCT/EP2024/053694

§ 371 Date: Aug. 5, 2025

(30) Foreign Application Priority Data
Feb. 16, 2023 (EP) 23157115.9

(51) Int. Cl. C22B 11/00; C22B 3/16; C25C 1/20

(52) U.S. Cl. CPC C22B 11/046; C22B 3/16; C25C 1/20

(57) ABSTRACT

The present disclosure relates to a method for leaching gold from a gold-bearing substrate. The method includes a step of treating the gold-bearing substrate with at least one leaching liquid substance thereby generating at least one pregnant leaching liquid substance containing leached gold. The at least one leaching liquid substance comprises at least one chloride salt and auric ions, with the proviso that when the leaching liquid substance is a non-aqueous leaching liquid substance, the non-aqueous leaching liquid substance further comprises at least one hydrogen bond donor comprising at least one hydroxyl group.

### FIELD OF THE INVENTION

The present invention relates to a method for leaching gold from a gold-bearing substrate. The present invention further relates to a leaching liquid substance and to the use of a leaching liquid substance for leaching gold.

### BACKGROUND OF THE INVENTION

The use of gold is widespread, and includes applications in jewelry and in the electronics industry. The combination of good electrical conductivity coupled with high resistance to corrosion has led to its widespread adoption as the standard material for contacts, bonding, joining, and high performance, high reliability conductor applications. In part due to its high intrinsic cost, gold is usually employed in the form of a thin layer in electrical and electronic equipment of many devices.

Gold can be extracted or recovered from substrates such as ores or waste from electrical and electronic equipment (WEEE) whereby this substrate is contacted with a leaching solution. However, this process is complicated because such substrates are complex matrices wherein gold is embedded. Liquid mercury is sometimes used to extract gold by amalgamation, but mercury is highly toxic. It is also known to use hazardous and/or toxic chemicals such as aqua regia (a mixture of concentrated nitric acid and concentrated hydrochloric acid) or cyanide solutions to dissolve gold.

Other processes with substantially reduced environmental issues have been developed to leach and recover gold out of gold-containing substrates.

For example, US 2009/241735 A1 discloses a process for leaching and recovering gold out of gold-containing sulfide or silicate ores at atmospheric pressure in an aqueous solution at a temperature below its boiling point. The purpose of this invention was to reduce the amount of reagent and to avoid the use of expensive, readily degradable and toxic agents. This process of leaching gold comprises first a step of leaching copper from an ore material containing gold whereby a gold leaching solution containing chloride ions and ferric ions is used. After the first step, the pH of the gold leaching solution is then adjusted to 1.9 or less in order to leach gold from the ore material into the gold leaching solution. However, this process is complex and far too specific since it can only be applied to substrates containing gold in the presence of copper.

WO 2013/152424 A1 discloses a process for the extraction of gold from a gold-bearing ore or concentrate. The purpose of this invention was notably to avoid environmental and other hazards associated with the use of cyanide to extract gold. This process comprises a step of leaching the gold-bearing ore or concentrate by using a leaching solution containing hydrochloric acid and magnesium chloride. The leaching step is carried out at atmospheric pressure, at a temperature of at least 90° C. and by applying an electric potential (Eh versus SHE (standard hydrogen electrode)) of at least 900 mV. After applying the electrical potential, the leach solution is subjected to an extra step of liquid/solid separation. This extra step of liquid/solid separation used after the leaching step makes the entire process more complex.

Therefore, there is thus a need for an improved method for leaching gold from gold-bearing substrates which method enables to recover and recycle gold from complex matrices, capable of separating gold from other valuable metals contained in the gold-bearing substrate thereby realizing a further valorization of these valuable metals while this method remains easy and is more environmental by limiting the amount of wastes.

### SUMMARY OF THE INVENTION

The inventors have now surprisingly found that it is possible to provide a new method fulfilling the above-mentioned needs.

Thus, there is now provided a method for leaching gold from a gold-bearing substrate, the method including the step (a) of treating the gold-bearing substrate with at least one leaching liquid substance thereby generating at least one pregnant leaching liquid substance containing leached gold, the at least one leaching liquid substance comprising:
(i) at least one chloride salt;
(ii) auric ions.
   with the proviso that when the leaching liquid substance is a non-aqueous leaching liquid substance, the non-aqueous leaching liquid substance further comprises (iii) at least one hydrogen bond donor comprising at least one hydroxyl group.

### DETAILED DESCRIPTION

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a method comprising the steps A and B” should not be limited to the method consisting only of steps A and B. It means that with respect to the present invention, the only relevant steps of the method are A and B. Accordingly, the terms “comprising” and “including” encompass the more restrictive terms “consisting essentially of” and “consisting of”.

As used herein, the terms “optional” or “optionally” means that a subsequently described event or circumstance can or cannot occur, and that the description includes instances where said event or circumstance occurs and instances where it does not.

Unless otherwise mentioned or indicated, it is to be understood that within the context of the present invention, the temperature is the room temperature.

Within the context of the present invention, the expression “room temperature”, is intended to denote a temperature comprised between 2° and 30° C., preferably comprised between 2° and 25° C., more preferably a temperature of 20° C.

According to one aspect of the present invention, the method according to the present invention is a method for leaching gold from a gold-bearing substrate, the method including the step (a) of treating the gold-bearing substrate with at least one leaching liquid substance thereby generating at least one pregnant leaching liquid substance containing leached gold, the at least one leaching liquid substance comprising:
(i) at least one chloride salt;
(ii) auric ions.
   with the proviso that when the leaching liquid substance is a non-aqueous leaching liquid substance, the non-aqueous leaching liquid substance further comprises (iii) at least one hydrogen bond donor comprising at least one hydroxyl group.

In other words, this means that the leaching liquid substance may be an aqueous leaching liquid substance or a non-aqueous leaching liquid substance. Mixtures of aqueous leaching liquid substance and non-aqueous leaching liquid substance leaching liquid substance can also be used for the purpose of the invention. When the leaching liquid substance is a non-aqueous leaching liquid substance, the non-aqueous leaching liquid substance further comprises (iii) at least one hydrogen bond donor comprising at least one hydroxyl group.

Advantageously, the method according to the present invention is a method for leaching gold from a gold-bearing substrate, the method including the step (a) of treating the gold-bearing substrate with at least one leaching liquid substance thereby generating at least one pregnant leaching liquid substance containing leached gold, the at least one leaching liquid substance being an aqueous liquid substance comprising:
(i) at least one chloride salt;
(ii) auric ions
or the leaching liquid substance being a non-aqueous leaching liquid substance comprising:
(i) at least one chloride salt;
(ii) auric ions;
(iii) at least one hydrogen bond donor comprising at least one hydroxyl group
or the leaching liquid substance being a mixture of (A) an aqueous liquid substance comprising (i) at least one chloride salt and (ii) auric ions and (B) a non-aqueous liquid substance comprising (i) at least one chloride salt, (ii) auric ions and (iii) at least one hydrogen bond donor comprising at least one hydroxyl group.

The method of the present invention includes a step (a) of treating the gold-bearing substrate with at least one leaching liquid substance thereby generating at least one pregnant leaching liquid substance containing leached gold.

In other words, the gold-bearing substrate is treated with at least one leaching liquid substance to leach at least part of the gold contained in the substrate thereby forming at least one liquid substance containing leached gold which is called pregnant leaching liquid substance.

Within the context of the present invention, the expression “at least one leaching liquid substance” is intended to denote one or more than one leaching liquid substance. Mixtures of leaching liquid substance can also be used for the purpose of the invention. In the remainder of the text, the expression “leaching liquid substance” is understood, for the purposes of the present invention, both in the plural and the singular form.

Within the context of the present invention, the expression “at least one pregnant leaching liquid substance”, is intended to denote one or more than one pregnant leaching liquid substance. In the remainder of the text, the expression “pregnant leaching liquid substance” is understood, for the purposes of the present invention, both in the plural and the singular form.

In general, the term “pregnant leaching liquid substance” is meant to refer to a leaching liquid substance having leached metal therein. It is understood that the pregnant leaching liquid substance according to the invention refers to the leaching liquid substance further comprising at least part of the gold coming from the gold-bearing substrate.

Within the context of the present invention, a gold-bearing substrate is intended to refer to a substrate containing at least gold, preferably gold presenting an oxidation state (also called oxidation number) of zero (0), Au(0). Such a gold-bearing substrate can be for example, a rock, an ore, a metal concentrate, a mined concentrate, an anode slime, a gold-bearing metallic scrap, a waste from electrical and electronic equipment (WEEE) and mixtures of the above. Preferably, the gold-bearing substrate is a waste from electrical and electronic equipment (WEEE). In general, gold contained in the gold-bearing substrate can be embedded within the substrate or present at the surface of the substrate or mixtures of the above.

Advantageously the gold-bearing substrate can be a whole gold-bearing substrate, a chunked gold-bearing substrate for example, milled, crushed or powdered. Preferably, the gold-bearing substrate is a chunked gold-bearing substrate.

In general, it is understood that any step of treating known by the skilled person can be used for treating the gold-bearing substrate with the aim to ensure the leaching of at least part of the gold from the gold-bearing substrate. In general, the leaching of a metal is a chemical treatment, also called processing. In the context of waste treatment, the term treatment means recovery or disposal operations, including preparation prior to recovery or disposal.

In general, in the treating step (a), the gold-bearing substrate is contacted with the at least one leaching liquid substance. Depending on the nature and the form of the gold-bearing substrate, this contacting step can be carried out in different manners. For example, the leaching liquid substance can be spilled onto the surface of the gold-bearing substrate, or the gold-bearing substrate can at least be partly or completely immersed in the leaching liquid substance, or the leaching liquid substance can flow over at least a part of the gold-bearing substrate, preferably, the gold-bearing substrate is completely immersed in the leaching liquid substance.

Contact time between the leaching liquid substance and the gold-bearing substrate can be selected to achieve desired recovery targets and processing goals.

Preferably, prior to and/or during the contacting step, the leaching liquid substance is agitated with the aim to improve the mass transport of the leaching liquid substance to the gold-bearing substrate.

In general, the agitation can be carried out by using bubbling or mechanical mixing such as notably traditional mixers and blenders, high intensity mixers and electric stirrers, said mixers, blenders and stirrers which can be equipped with at least one dispersion disk. When a magnetic stirrer is used, the speed of rotation of the magnetic stirrer is preferably equal to or greater than or equal to 500 rotations per minute, more preferably greater than or equal to 1000 rotations per minute, most preferably greater than or equal to 1500 rotations per minute.

In general, the leaching liquid substance can be used at room temperature or can be heated prior to and/or during the contacting step. In a preferred embodiment of the method according to the present invention, the leaching liquid substance can be heated prior to and/or during the contacting step in order to improve the kinetics of the leaching of gold. For example, the leaching liquid substance can be heated before being spilled onto the surface of the gold-bearing substrate. Alternatively, the leaching liquid substance can be heated before and/or during the partial or complete immersion of the gold-bearing substrate in the leaching liquid substance. Advantageously the temperature of the leaching liquid substance is equal to or greater than 30° C., more preferably, equal to or greater than 40° C., most preferably equal to or greater than 50° C. It is further understood that the upper limit of the temperature is equal to or less than 100° C., preferably equal to or less than 80° C., more preferably equal to or less than 60° C. In a preferred embodiment of the method of the present invention, the temperature is from 30° C. to 100° C., preferably from 40° C. to 80° C., more preferably from 50° C. to 60° C.

In general, the skilled in the art will be able to select the appropriate pH of the leaching liquid substance.

Unless otherwise mentioned or indicated, the pH is to be understood as the apparent pH. Within the context of the present invention, pH is understood as the value displayed by a potentiometric pH-meter, previously calibrated with conventional aqueous buffers, when a glass pH-electrode is immersed in the leaching liquid substance.

The employed pH-meter was a Metrohm 827pHLab and the combined pH electrode a Metrohm 6.0226.010. The aqueous calibration buffers (VWR AVS Titrinorm) were 4.00, 7.00 and 10.00. The calibration was performed at 22±3° C.

In the rest of the text, the terms “pH” and “apparent pH” have the same meaning and may be used interchangeably.

Preferably, the pH of the leaching liquid substance is equal to or less than 5.0, more preferably equal to or less than 4.0, most preferably equal to or less than 3.0, even more preferably equal to or less than 2.8.

In general, leaching liquid substances are known to the skilled person in the art of metallurgy and metal extraction and recovery techniques applied therein. Generally, leaching liquid substances have electrical conductive properties. In general, the leaching liquid substance also called leaching solution, is meant to refer to a liquid, a solution, that allows to detach or extract a metal from its carrier substance, namely the substrate, based on its relative affinity for the metal. In general, the leaching liquid substance comprises a solvent and salts as solute. Preferably, an appropriate polar solvent is chosen such as to provide the electrical conductive properties to the leaching liquid substance.

According to the invention, the leaching liquid substance may be an aqueous leaching liquid substance or a non-aqueous leaching liquid substance. Mixtures of aqueous leaching liquid substance and non-aqueous leaching liquid substance leaching liquid substance can also be used for the purpose of the invention.

According to a certain embodiment, the leaching liquid substance is an aqueous leaching liquid substance. Within the context of the present invention, an aqueous leaching liquid substance is intended to refer to a leaching liquid substance in which the liquid which acts as a solvent is water.

In another embodiment of the invention, the leaching liquid substance is a non-aqueous leaching liquid substance. Within the context of the present invention, a non-aqueous leaching liquid substance is intended to refer to a leaching liquid substance, in which any liquid other than water acts as a solvent, also called non-aqueous solvent. Suitable non-aqueous solvents may be organic or inorganic.

According to a preferred embodiment of the present invention, the non-aqueous solvent is an organic solvent. Generally, some non-limiting examples of suitable organic solvent include ethylene glycol, glycerol, propylene glycol, valérolactone.

In this embodiment, preferably, the “non-aqueous leaching liquid substance” refers to a substance which is substantially free of water. The expression “substantially free of water” is intended to denote that the non-aqueous leaching liquid substance contains less than 30 wt. %, more preferably less than 20 wt. %, most preferably less than 10 wt. % water, relative to the total weight of the non-aqueous leaching liquid substance.

According to the invention, the at least one leaching liquid substance comprises (i) at least one chloride salt and (ii) auric ions with the proviso that when the leaching liquid substance is a non-aqueous leaching liquid system, the non-aqueous leaching liquid substance further comprises (iii) at least one hydrogen bond donor comprising at least one hydroxyl group. The inventors have surprisingly found that when a leaching liquid substance comprising (i) at least one chloride salt and (ii) auric ions, with the proviso that when the leaching liquid substance is a non-aqueous leaching liquid substance, the non-aqueous leaching liquid substance further comprises (iii) at least one hydrogen bond donor comprising at least one hydroxyl group, is used to treat a gold-bearing substrate, at least part of gold is leached out the gold bearing substrate. The leached gold is then contained in the pregnant leaching liquid substance and can be further recovered if needed. Without being bound to this theory, Au(0) in the gold-bearing substrate might interact with auric ions, Au(III) to form aurous ions, Au(I), in solution, according to the following comproportionation reaction:

$$Au ( III ) + 2 Au ( 0 ) ⇌ 3 Au ( I )$$

Au(III) acts as a leaching agent enabling thus the leaching of gold. Even though the leaching agent is expensive, being composed of gold, the reaction shows that 1 equivalent of Au(III) injected allows the recovery of 3 equivalents of Au(I). Also, the reduction product of the leaching agent and the oxidation product of the gold in the gold-bearing substrate are the very same species, namely the Au(I), which is an outstanding advantage for the subsequent purification/selective recovery of gold.

This comproportionation reaction is absolutely not expected in methods known to date. Indeed, the examination of the standard potentials associated with the Au(III)/Au(I), Au(I)/Au(0) and Au(III)/Au(0) redox couples predicts that the comproportionation reaction is not spontaneous (in the standard conditions) but that the reverse disproportionation reaction is the spontaneous one. Even for the skilled person, the occurrence of the comproportionation reaction is unexpected. However, the inventors have now demonstrated that the equilibrium can be quantitatively shifted to the right (i.e. towards the dissolution of Au(0)) through the method according to the present invention.

The present invention provides a solution for the leaching of gold through a green chemistry approach, easy to implement and facilitating the subsequent recovery of dissolved gold. In view of the high market value of gold and the public policies favouring metal recycling and recovery, for example from WEEE, the present invention has an economic potential.

### Auric Ions

As said, the leaching liquid substance comprises auric ions. In other words, the leaching liquid substance comprises trivalent gold ions, namely gold having an oxidation state of +3, Au(III).

In the context of the present invention, any source of gold which is capable of providing auric ions, as detailed above, may be used.

For example, auric ions can be provided to the leaching liquid substance by means of at least an auric salt. In general, auric salts are known to the skilled person in the art. Non-limiting examples of auric salts are AuCl₃, HAuCl₄, KAuCl₄, AuBr₃ and C₆H₉AuO₆. Within the context of the present invention, auric salts may be in an anhydrous form and/or in a hydrated form.

Alternatively or additionally, auric ions may be in situ generated in the leaching liquid substance through an oxidation of gold ions having an oxidation state lower than +3. During this oxidation, gold ions presenting an oxidation state lower than +3 are oxidized in order to generate auric ions, having an oxidation state of +3, in the leaching liquid substance.

In general, the oxidation of gold ions having an oxidation state lower than +3 can be carried out by known methods in the art such as by an electrochemical method and/or a chemical method (chemical oxidation), preferably the oxidation of gold is carried out by an electrochemical method.

Within the context of the present invention, the concentration may be expressed in molar (mol/l) or in molal (mol/kg). The expression “molal” is intended to denote the number of moles of solute (e.g. salt) per kilogram of liquid substance.

Advantageously, the auric ions are present in the leaching liquid substance in a concentration of at least 0.5 mmol/kg, preferably at least 1.0 mmol/kg, more preferably at least 2.0 mmol/kg.

It is further understood that the upper limit of the concentration of the auric ions in the leaching liquid substance is equal to or less than the solubility limit of the solute (auric ions) within the leaching liquid substance.

Preferably, the upper limit of the concentration of the auric ions in the leaching liquid substance is equal to or less than 20.0 mmol/kg, preferably equal to or less than 15.0 mmol/kg, more preferably equal to or less than 10.0 mmol/kg.

In a preferred embodiment of the method of the present invention, the auric ions, as detailed above, are present in the leaching liquid substance in a concentration from 0.5 mmol/kg to 20.0 mmol/kg, more preferably from 1.0 mmol/kg to 15.0 mmol/kg, most preferably from 2.0 mmol/kg to 10.0 mmol/kg.

### Chloride Salt

Within the context of the present invention, the expression “at least one chloride salt” is intended to denote one or more than one chloride salt. Mixtures of chloride salts can also be used for the purpose of the invention. In the remainder of the text, the expression “chloride slat” is understood, for the purposes of the present invention, both in the plural and the singular form.

In general, chloride salts being able to be used in leaching liquid substances are known to the skilled person in the art.

Suitable chloride salts may be organic or inorganic.

Non-limiting examples of inorganic chloride salts may be made of sodium chloride, potassium chloride, lithium chloride, ammonium chloride, calcium chloride and magnesium chloride.

According to a preferred embodiment of the present invention, the chloride salt is an organic chloride salt.

In a preferred embodiment of the present invention, the organic chloride salt is a compound according to formula (V),

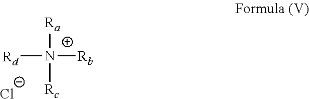

wherein each of Rₐ, R_{b}, R_{c}, and R_{d}, independently from each other are selected from C₁₋₄ alkyl or C₃₋₆ cycloalkyl, wherein said alkyl and cycloalkyl are optionally substituted with one or more substituents selected from the group consisting of OR₄₁, OC(═O)R₄₁, C(═O)OR₄₁, C(═O)R₄₁ or phenyl, wherein said R₄₁ is, independently from each other, selected from the group consisting of hydrogen, halo or C₁₋₄ alkyl.

In a preferred embodiment of the present invention, Rₐ of the organic chloride salt is C₁₋₄ alkyl, wherein said alkyl is optionally substituted with one or more substituents selected from the group consisting of OR₄₁, CH(═O), OC(═O)R₄₁, C(═O)OR₄₁, C(═O)R₄₁ or phenyl, wherein said R₄₁ is, independently from each other, selected from the group consisting of hydrogen, halo or C₁₋₄ alkyl. More preferably, Rₐ of the organic chloride salt is C₁₋₄ alkyl, wherein said alkyl is optionally substituted with one or more substituents selected from the group consisting of OR₄₁, OC(═O)R₄₁, C(═O)R₄₁ or phenyl, wherein said R₄₁ is, independently from each other, selected from the group consisting of hydrogen or halo.

In a preferred embodiment of the present invention, R_{b} of the organic chloride salt is C₁₋₄ alkyl, wherein said alkyl is optionally substituted with one or more substituents selected from the group consisting of OR₄₁, OC(═O)R₄₁, C(═O)OR₄₁, C(═O)R₄₁ or phenyl, wherein said R₄₁ is, independently from each other, selected from the group consisting of hydrogen, halo or C₁₋₄ alkyl. More preferably, R_{b} of the organic chloride salt is C₁₋₄ alkyl, wherein said alkyl is optionally substituted with one or more substituents selected from the group consisting of OR₄₁, OC(═O)R₄₁, C(═O)R₄₁ or phenyl, wherein said R₄₁ is, independently from each other, selected from the group consisting of hydrogen or halo.

In a preferred embodiment of the present invention, R_{c} of the organic chloride salt is C₁₋₄ alkyl, wherein said alkyl is optionally substituted with one or more substituents selected from the group consisting of OR₄₁, OC(═O)R₄₁, C(═O)OR₄₁, C(═O)R₄₁ or phenyl, wherein said R₄₁ is, independently from each other, selected from the group consisting of hydrogen, halo or C₁₋₄ alkyl. More preferably, R_{c} of the organic chloride salt is C₁₋₄ alkyl, wherein said alkyl is optionally substituted with one or more substituents selected from the group consisting of OR₄₁, OC(═O)R₄₁, C(═O)R₄₁ or phenyl, wherein said R₄₁ is, independently from each other, selected from the group consisting of hydrogen or halo.

In a preferred embodiment of the present invention, R_{d} of the organic chloride salt is C₁₋₄ alkyl, wherein said alkyl is optionally substituted with one or more substituents selected from the group consisting of OR₄₁, OC(═O)R₄₁, C(═O)OR₄₁, C(═O)R₄₁ or phenyl, wherein said R₄₁ is, independently from each other, selected from the group consisting of hydrogen, halo or C₁₋₄ alkyl. More preferably, R_{d} of the organic chloride salt is C₁₋₄ alkyl, wherein said alkyl is optionally substituted with one or more substituents selected from the group consisting of OR₄₁, OC(═O)R₄₁, C(═O)R₄₁ or phenyl, wherein said R₄₁ is, independently from each other, selected from the group consisting of hydrogen or halo.

Advantageously, the organic chloride salt is a quaternary ammonium chloride, preferably, the quaternary ammonium chloride is selected from the group consisting of (2-hydroxyethyl)trimethylammonium chloride (i.e. choline chloride); ethyl(2-hydroxyethyl)dimethylammonium chloride; Ethanaminium, 2-[(chlorocarbonyl)oxy]-N, N, N-trimethyl-, chloride; 2-hydroxyethyl(trimethyl)azanium, carbonochloridate, chloride; benzyl (2-hydroxyethyl)dimethylammonium chloride, or any combination thereof, more preferably, the organic chloride salt is (2-hydroxyethyl)trimethylammonium chloride.

In a certain embodiment, when the leaching liquid substance is an aqueous leaching liquid substance, advantageously, the chloride salt is present in the aqueous leaching liquid substance in a concentration equal to or greater than 1.0 mol/l, preferably equal to or greater than 2.0 mol/l, more preferably equal to or greater than 3.0 mol/l.

It is further understood that the upper limit of the concentration of the chloride salt in the aqueous leaching liquid substance is equal to or less than the solubility limit of the solute (chloride salt) within the aqueous leaching liquid substance.

Preferably, the upper limit of the concentration of the chloride salt in the leaching liquid substance is equal to or less than 6.0 mol/l, preferably equal to or less than 5.0 mol/l, more preferably equal to or less than 4.0 mol/l.

In a preferred embodiment of the method of the present invention, the chloride salt is present in the aqueous leaching liquid substance in a concentration from 1.0 mol/l to 6.0 mol/l, more preferably from 2.0 mol/l to 5.0 mol/l, most preferably from 3.0 mol/l to 4.0 mol/l.

In another embodiment, when the leaching liquid substance is a non-aqueous leaching liquid substance, advantageously, the chloride salt is present in the non-aqueous leaching liquid substance in a concentration equal to or greater than 1.0 mol/kg, preferably equal to or greater than 2.0 mol/kg, more preferably equal to or greater than 3.0 mol/kg.

It is further understood that the upper limit of the concentration of the chloride salt in the non-aqueous leaching liquid substance is equal to or less than 15.0 mol/kg, preferably equal to or less than 10.0 mol/kg, more preferably equal to or less than 5 mol/kg.

In a preferred embodiment of the method of the present invention, the chloride salt is present in the non-aqueous leaching liquid substance in a concentration from 1.0 mol/kg to 15.0 mol/kg, more preferably from 2.0 mol/kg to 10.0 mol/kg, most preferably from 3.0 mol/kg to 5 mol/kg.

As said, when the leaching liquid substance is a non-aqueous leaching liquid system, the non-aqueous leaching liquid substance further comprises (iii) at least one hydrogen bond donor comprising at least one hydroxyl group [hydrogen bond donor or HBD, herein after].

### Hydrogen Bond Donor (HBD)

Within the context of the present invention, the expressions “at least one hydrogen bond donor” and “at least one hydroxyl group” are intended to denote one or more than one “hydrogen bond donor” and one or more than one “hydroxyl group”, respectively. In the remainder of the text, the expressions “hydrogen bond donor” and “hydroxyl group” are understood, for the purposes of the present invention, both in the plural and the singular form.

In general, hydrogen bond donors being able to be used in non-aqueous leaching liquid substances are known to the skilled person in the art.

In a preferred embodiment of the present invention, the HBD is a compound chosen among those of formula (I) or (II), and isosorbide, fructose, and glucose, and stereoisomers thereof:

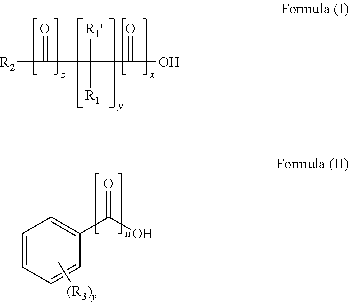

wherein:
x is an integer equal to 0 or 1;
each of R₁ and R₁′, independently from each other and at each occurrence, is selected from hydrogen or OR₁₂, wherein each of R₁₂ is hydrogen or a C₁₋₄ alkyl;
y is an integer in the range from 0 to 6;
z is an integer equal to 0 or 1;
R₂ is selected from the group consisting of hydrogen, a C₁₋₄ alkyl and OR₂₂, wherein R₂₂ is an hydrogen or a C₁₋₄ alkyl;
u is an integer equal to 0 or 1;
each of R₃ is selected from the group consisting of hydrogen, C₁₋₄ alkyl and C(═O)OR₃₁, wherein each of R₃₁ is hydrogen or C₁₋₄ alkyl;
v is an integer in the range of 0 to 5;

Preferably, the HBD is selected from the group consisting of glycerol, ethylene glycol, propylene glycol, acetic acid, levulinic acid, oxalic acid, mellitic acid, tartronic acid, tartaric acid, propionic acid, malonic acid, lactic acid, acetoacetic acid, succinic acid, benzoic acid, adipic acid, citric acid, phenol, o-cresol, xylenol, xylitol, sorbitol, isosorbide, fructose, glucose, or any combination thereof, more preferably the hydrogen bond donor is selected from the group consisting of glycerol, levulinic acid, oxalic acid, malonic acid, ethylene glycol, lactic acid.

As used in the foregoing and hereinafter, the following definitions apply unless otherwise noted.

The term halo-alone or in combination means all halogens, that is, chloro (Cl), bromo (Br), fluoro (F), iodo (I).

The term alkyl-alone or in combination, means an alkane-derived radical containing from 1 to 4 carbon atoms, unless otherwise specified, for example C_{F-G} alkyl defines a straight or branched alkyl radical having from F to G carbon atoms, e.g. C₁₋₄ alkyl defines a straight or branched alkyl radical having from 1 to 4 carbon atoms such as for example methyl, ethyl, 1-propyl, 2-propyl, 1-butyl, 2-butyl, 2-methyl-1-propyl. An alkyl group may be a straight chain alkyl or branched alkyl.

The term cycloalkyl refers to a cyclic or polycyclic alkyl group containing 3 to 6 carbon atoms. Preferably, cycloalkyl groups are monocyclic, bicyclic or tricyclic ring systems of 3-6, ring members per ring, such as cyclopropyl, cyclopentyl, cyclohexyl, adamantyl and the like.

In the method of the present invention, the leaching liquid substance of the present invention can be prepared by a variety of methods known in the art.

In the method of the present invention, the leaching liquid substance is prepared by a process comprising an intimate admixing of the various components as comprised in the leaching liquid substance, as detailed above. Furthermore, it is understood that any order of intimate admixing of the various components as comprised in the leaching liquid substance, as detailed above, is acceptable.

Generally said intimate admixing, as detailed above, may be carried out by using a variety of admixing means known in the art. Non-limiting examples of such admixing means are for example bubbling or mechanical mixing such as traditional mixers and blenders, high intensity mixers and electric stirrers, said mixers, blenders and stirrers which can be equipped with at least one dispersion disk.

It is understood that the skilled person in the art will carry out said intimate admixing according to general practice such as notably using optimal times, weights, volumes and batch quantities.

The intimate admixing may be performed at room temperature. Preferably, the intimate admixing is performed at a temperature equal to or greater than 30.0° C., more preferably, equal to or greater than 40.0° C., most preferably equal to or greater than 50.0° C. It is further understood that the upper limit of the temperature is equal to or less than 80.0° C., preferably equal to or less than 70.0° C., more preferably equal to or less than 60.0° C. In a preferred embodiment of the method of the present invention, the temperature is from 30.0° C. to 80.0° C., preferably from 40.0° C. to 70.0° C., more preferably from 50.0° C. to 60.0° C.

According to certain embodiments of the method according to the present invention, prior to said intimate admixing, the chloride salt, as detailed above, and/or the auric ions, as detailed above, may be first solubilized in at least one polar solvent.

The polar solvent can be a polar organic solvent. Non-limiting examples of suitable polar organic solvents notably include ethylene glycol, glycerol, propylene glycol, lactic acid.

Alternatively, the polar solvent can be a polar aqueous solvent such as water. Within the context of the present invention, the expression “one or more than one polar solvent” is intended to denote one or more than one polar solvent. Mixtures of polar solvents, organic and/or aqueous polar solvents, can also be used for the purpose of the present invention.

According to a certain embodiment, when the leaching liquid substance is an aqueous leaching liquid substance, said intimate admixing, as detailed above, is preferably carried out by using water as solvent.

In another embodiment, when the leaching liquid substance is a non-aqueous leaching liquid substance, advantageously the non-aqueous leaching liquid substance is prepared by a process comprising an intimate admixing of the chloride salt, as detailed above, the auric ions, as detailed above and the hydrogen bond donor, as detailed above.

In this embodiment, in the preparation of the non-aqueous leaching liquid substance, the chloride salt, as detailed above, and the hydrogen bond donor, as detailed above, may be first mixed to form a first liquid substance. The auric ions, as detailed above can then be further added to the first liquid substance to obtain the non-aqueous leaching liquid substance.

Preferably, this first liquid substance is a deep eutectic mixture having a melting point lower than 100° C., preferably lower than 80° C., more preferably lower than 60° C.

It is generally known in the art that when a solvent is a deep eutectic solvent (DES) having for example a melting point lower than 100° C. that such solvent can be made by mixing in an appropriate molar ratio two or more salts, which salts are each solid at 100° C., thereby forming an eutectic system which melts at lower than 100° C.

Preferred deep eutectic mixtures suitable for use in the method of the present invention are notably described in the document of Abbott et al. (Abbott et al. Deep Eutectic solvents formed between choline chloride and carboxylic acids, J. Am. Chem. Soc, 2004, vol. 126, NO. 29, pages 9142-9147), in which the so-called Deep Eutectic Solvents are prepared by using a hydrogen bond donor (carboxylic acids) to complex the anion from the chloride salt (quaternary ammonium salts).

In a preferred embodiment of the method according to the present invention, the first liquid substance is a deep eutectic mixture having a melting point lower than 100° C., preferably lower than 80° C., more preferably lower than 60° C., which is formed by intimate admixing at least one organic chloride salt being a quaternary ammonium chloride selected from the group consisting of (2-hydroxyethyl)trimethylammonium chloride (i.e. choline chloride); ethyl(2-hydroxyethyl)dimethylammonium chloride; Ethanaminium, 2-[(chlorocarbonyl)oxy]-N, N, N-trimethyl-, chloride; 2-hydroxyethyl(trimethyl)azanium, carbonochloridate, chloride; benzyl (2-hydroxyethyl)dimethylammonium chloride or any combination thereof, with at least one hydrogen bond donor selected from the group consisting of glycerol, ethylene glycol, acetic acid, levulinic acid, oxalic acid, mellitic acid, tartronic acid, tartaric acid, propionic acid, malonic acid, lactic acid, acetoacetic acid, succinic acid, benzoic acid, adipic acid, succinic acid, citric acid, phenol, o-cresol, xylenol, xylitol, sorbitol, isosorbide, fructose, glucose, or any combination thereof.

In this embodiment, preferably, the intimate admixing is performed at a temperature equal to or greater than the melting point of the first liquid substance in order to ensure and achieve its effective and homogeneous melting, advantageously, at a temperature equal to or greater than 20.0° C., more preferably, equal to or greater than 30.0° C., most preferably equal to or greater than 40.0° C. It is further understood that the upper limit of the temperature is equal to or less than 90.0° C., preferably equal to or less than 80.0° C., more preferably equal to or less than 70.0° C., most preferably equal to or less than 60.0° C. In a preferred embodiment of the method of the present invention, the temperature is from 20.0° C. to 80.0° C., preferably from 30.0° C. to 70.0° C., more preferably from 40.0° C. to 60.0° C.

It is further understood that depending on the nature of the organic chloride salt, as detailed above and the hydrogen bond donor, as detailed above, the appropriate molar ratio of the organic chloride salt, to the hydrogen bond donor can be determined according to standard practice in the art.

Preferably, the skilled in the art will be able to select the appropriate molar ratio of the organic chloride salt, to the hydrogen bond donor in order to obtain a first liquid substance which is liquid at a temperature as detailed above, preferably which is liquid at room temperature.

Preferably, the molar ratio of the organic chloride salt to the hydrogen bond donor is from 1:1 to 1:2.

The method according to the present invention may further comprise the following step:
step (b): subjecting the at least one pregnant leaching liquid substance obtained in step (a) to an electrodeposition process thereby collecting at the cathode at least part of the leached gold while forming at the anode auric ions which remain in the resulting leaching liquid substance.

The method according to the present invention may further comprise the following step:

step (c): adding to step (a) at least part of the resulting leaching liquid substance obtained in step (b).

During the electrodeposition process, metallic gold is formed at the cathode. As the metallic gold is formed at the cathode, the anode will oxidize aurous ions, Au(I), in auric ions, Au(III). Therefore, the metallic gold which is in the solid form can be recovered from the pregnant leaching liquid substance while the auric ions remain in the resulting leaching liquid substance. If desired, this resulting leaching liquid substance can then be reused in step (a) as leaching liquid substance.

In the method of the present invention, the electrodeposition process can be carried out in a variety of devices known in the art. During the electrodeposition process a variety of types electrodes can be used, for example, any conductive substrate such as graphite, glassy carbon, platinum, stainless steel, titanium or any suitable metal or alloy.

It is further understood that depending on the leaching liquid substance, as detailed above and the nature of the electrode, as detailed above, the appropriate electrical potential applied at the electrodes can be determined according to standard practice in the art. Furthermore, it is understood that any electrical potential suitable for collecting gold at the cathode and/or forming auric ions at the anode is acceptable.

Preferably, step (a) of the method is performed in a first container. Then, if desired, the pregnant leaching liquid substance generated in this first container can be transferred from this first container to a second container wherein step (b) occurs. If desired, at least part of the resulting leaching liquid substance obtained in step (b) in the second container can be transferred from the second container to the first container to perform again step (a).

Preferably, the method according to the present invention is a continuous method.

The leaching liquid substance, as detailed above, is another aspect of the present invention.

It is further understood that all definitions and preferences, as described above, equally apply for the leaching liquid substance.

The use of a leaching liquid substance, as detailed above, for leaching gold is another aspect of the invention.

It is further understood that all definitions and preferences, as described above, equally apply for the use of the leaching liquid substance for leaching gold.

### FIGURES

Other advantages and particularities of the present invention will become apparent from the following description of some particular embodiments of the method according to the present invention. This description is only given by way of example and is not intended to limit the scope of the invention. The reference numerals used in the description relate to the annexed drawings wherein:

FIG. 1. is a measurement of the open circuit potential by chronopoteniometry (electrochemical measurements) according to examples 3-6; and

FIG. 2. is a graph of the time τ, which corresponds to the jump of the ocp, as a function of the deposition time according to example 7;

FIG. 3. is a measurement of the open circuit potential by chronopoteniometry (electrochemical measurements) according to example 24;

FIG. 4. is a measurement of the open circuit potential by chronopoteniometry (electrochemical measurements) according to example 26;

and

FIG. 5a. is a diagram of an installation for carrying out a method according to a particular embodiment of the present invention.

FIG. 5b. is a diagram of the electrodeposition process according to a particular embodiment of the present invention.

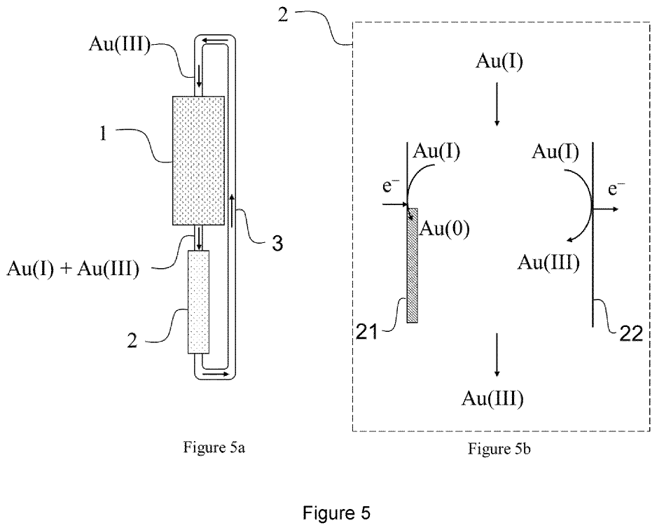

The installation schematically illustrated in FIG. 5a comprises a first container 1 arranged to contain the leaching liquid substance. It is also in this first container 1 that the gold-bearing substrate is treated by the leaching liquid substance to generate the pregnant leaching liquid substance containing leached gold. The first container 1 can be equipped with a first supply means suitable to provide the gold-bearing substrate to the first container 1, which has not been indicated in FIG. 5a. If desired, the first container 1 can be equipped with a second supply means suitable to provide the leaching liquid substance to the first container 1, which has not been indicated in FIG. 5a.

As detailed above, during the leaching of gold, at least part of the auric ions, Au(III) have been reduced into aurous ions, Au(I), which are contained in the pregnant leaching liquid substance. In this embodiment, the pregnant leaching liquid substance is transferred from the first container 1 to the second container 2 wherein the pregnant leaching liquid substance is subjected to an electrodeposition process. This electrodeposition process is schematically illustrated in FIG. 5b. During the electrodeposition process, the conditions are set so that leached gold (i.e. Au(I)) contained in the pregnant leaching liquid substance is reduced at the cathode 21 to form metallic gold, Au(0), while leached gold (i.e. Au(I)) is oxidized at the anode 22 to form auric ions, Au(III). Therefore, metallic gold, Au(0) can be collected at the cathode 21 while auric ions, Au(III), formed at the anode 22 remain in the resulting leaching liquid substance. As shown in the installation illustrated in FIG. 5a, the resulting leaching liquid substance can be transferred from the second container 2 to the first container 1, for example by means of a duct 3 suitable to transport a liquid substance. This can be done by means of a pump which has not been indicated in FIG. 5a. The resulting leaching liquid substance which contains the chloride salt, the hydrogen bond donor and auric ions is suitable to be reused as leaching liquid substance to leached gold in the first container 1. The method might be a continuous method. The leaching liquid substance can be circulated from the first container 1 to the second container 2 and then to the first container 1 in a closed loop.

### EXAMPLES

The invention will be now described in more details with reference to the following examples, whose purpose is merely illustrative and not intended to limit the scope of the invention.

### Raw Materials

The following raw materials have been used in the following examples (Table 1). These compounds are commercially available.

TABLE 1
Compounds used in the examples

| | Abbreviation | Purity | Company |
|---|---|---|---|
| Chloride salt | | | |
| (2-hydroxyethyl) | ChCl | +98% | Alfa Aesar |
| trimethylammonium | | | |
| chloride | | | |
| (i.e. choline | | | |
| chloride) | | | |
| KCl | / | Reagent | VWR Chemicals, |
| | | grade | AnalaR |
| | | | NORMAPUR |
| NaCl | / | Reagent | VWR Chemicals, |
| | | grade | AnalaR |
| | | | NORMAPUR |
| LiCl | / | 98% | Merck |
| Hydrogen Bond | | | |
| Donor (HBD) | | | |
| Oxalic acid | Oxa | Reagent | VWR Chemicals, |
| dihydrate | | grade | AnalaR |
| | | | NORMAPUR |
| Levulinic acid | Lev | 98% | Sigma-Aldrich |
| Glycerol | Gly | +99% | Acros Organics |
| Urea | U | 99.5+% | VWR Chemicals, |
| | | | AnalaR |
| | | | NORMAPUR |
| Malonic acid | Malo | 99% | VWR Chemicals, |
| | | | AnalaR |
| | | | NORMAPUR |
| Lactic acid | Lac | 90% | VWR Chemicals, |
| | | | AnalaR |
| | | | NORMAPUR |
| Ethylene glycol | EG | Reagent | VWR Chemicals, |
| | | grade | AnalaR |
| | | | NORMAPUR |
| Gold salt | | | |
| AuCl₃ | Au(III) | +64.4% | Alfa Aesar |
| | | (metal base) | |
| AuCl | Au(I) | +98.0% | Alfa Aesar |
| HAuCl₄•3H₂O | | +99.9% | Alfa Aesar |

### Test Methods

### Measurements of the Open Circuit Potential by Chronopotentiometry (Electrochemical Measurements)

Chronopotentiometric experiments at zero current consists in recording the potential (E) as a function of time (t) using a conventional three electrodes cell (working, auxiliary and reference electrodes). In this technique, the potential (E) is measured between the working and reference electrodes. Because no current is applied between the working and auxiliary electrodes, the potential which is recorded is called open circuit potential (herein after, also called ocp). By this method of studying the relationship between E and t in the chronopotentiometry graph, we can get the information of mechanisms of electrode reactions, such as the leaching of gold out of the gold-bearing substrate. In all the examples, unless otherwise specified, the chronopotentiometric experiments at zero current were performed at 60° C. in different leaching liquid substances and on different gold bearing substrates (working electrodes).

### Materials for the Electrochemical Measurements

The electrochemical experiments were carried out using an Autolab PGSTAT 30 (Metrohm) controlled by Nova 2.0 software. A conventional three electrode cell was used. The working electrode was a rotating disk electrode (geometric area: 0.0707 cm², rotation speed: 2000 rpm) and the auxiliary electrode a platinum grid presenting a high surface area. In non-aqueous leaching liquid substances, a silver wire was used as the pseudo-reference electrode. In aqueous leaching liquid substances, the reference electrode was a silver|silver chloride|aqueous 3M KCl. Prior to use, the electrodes have been cleaned. The working electrode was polished with a 1.0 mm alumina-water slurry on a smooth polishing cloth (Struers) then sonicated for 3 minutes and rinsed thoroughly with Milli-Q water and finally dried under nitrogen. The auxiliary electrode, platinum grid, was cleaned by heating in a flame to red glow. The silver wire used as pseudo-reference electrode was polished with silicon carbide abrasive paper.

Prior to use, all parts in contact with the solution were cleaned with demineralized water (Milli-Q water) and dried in a drying oven.

### Preparation of the Gold Bearing Substrate

The gold-bearing substrates were prepared by using a working electrode made from platinum (herein after also called Pt) or glassy carbon (herein after also called GC) as support and means for recording the electrochemical measurements, as detailed herein above. Some examples according to the invention were performed on Pt or GC electrodes covered by gold which are then called Au|Pt and Au|GC, respectively and which correspond to gold-bearing substrates. These gold-bearing substrates were prepared by an electrodeposition process during which a Pt or a GC working electrode was placed in a liquid substance containing a gold salt, as detailed below. The reduction potential of gold was then applied at the electrode in order to deposit metallic gold at the surface of the electrode. The reduction potentials that were used to prepare the gold bearing substrates Au|Pt and Au|GC are summarized in Table 4, herein below. Unless otherwise specified, the deposition time (time during which the reduction potential is applied at the electrode) was 30 s. If other deposition times were used, the conditions are specified in the following examples. The longer the deposition time, the higher the quantity of gold in the resulting gold-bearing substrate. The examples according to the invention were performed under agitation by means of the working electrode which was a rotating disc electrode with a rotation rate of 2000 rpm.

Alternatively, when specified, a gold-coated glass was used as gold-bearing substrate.

### Examples Using Non-Aqueous Leaching Liquid Substance

### Preparation of the Non-Aqueous Leaching Liquid Substance

The non-aqueous leaching liquid substances were prepared by adding different gold salts in different deep eutectic mixtures, as described herein below.

Firstly, the deep eutectic mixtures were prepared by mixing an adequate molar ratio of a chloride salt to a Hydrogen Bond Donor (HBD), as detailed below. The mixtures were heated at 60° C. and maintained at 60° C. for 120 min under magnetic stirring until a clear liquid was obtained (liquid substance).

Then, a gold salt was added to a clear deep eutectic mixture, in a quantity as specified below. The resulting mixtures were heated at 60° C. and maintained at 60° C. under magnetic stirring until the complete dissolution of the gold salt to obtain the non-aqueous leaching liquid substance.

The quantity of gold salt is expressed in molality which is the number of moles of solute (gold salt) per kilogram of solvent (deep eutectic mixture).

TABLE 2
Deep eutectic mixtures

| | Chloride salt | HBD | Molar ratio* | Name |
|---|---|---|---|---|
| 1 | ChCl | Oxa | 1:1 | ChCl-Oxa |
| 2 | ChCl | Gly | 1:2 | ChCl-Gly |
| 3 | ChCl | Lev | 1:2 | ChCl-Lev |
| 4 | ChCl | U | 1:2 | ChCl-U |
| 5 | ChCl | EG | 1:2 | ChCl-EG |

*molar ratio of the organic chloride salt to the hydrogen bond donor (chloride salt:HBD)

The apparent pH of the leaching liquid substances was measured as described above.

TABLE 3
apparent pH of the non-aqueous leaching liquid substances

| | Ref.* | HAuCl₄ | AuCl₃ |
|---|---|---|---|
| ChCl-Oxa | −1.02 | | −1.03 |
| ChCl-Gly | +4.95 | −0.39 | +0.86 |
| ChCl-Lev | +1.07 | | +0.07 |
| ChCl-U | +9.64 | | +6.70 |
| ChCl-EG | +6.67 | +0.10 | +0.88 |

*no auric salt

The gold-bearing substrates were prepared as detailed above.

TABLE 4
Preparation of the gold-bearing substrates

| | 1 | 2 | 3 | 4 | 5 | 6 | 7 | 8 | 9 | 10 |
|---|---|---|---|---|---|---|---|---|---|---|
| Liquid | ChCl- | ChCl- | ChCl- | ChCl- | ChCl- | ChCl- | ChCl- | ChCl- | ChCl- | NaCl |
| substance | Oxa | Oxa | Gly | Gly | Lev | Lev | U | U | EG | |
| Electrode | Pt | GC | Pt | GC | Pt | GC | Pt | GC | Pt | Pt |
| Reduction | +0.55 | −0.15 | +0.30 | +0.30 | +0.30 | +0.30 | −0.05 | −0.30 | +0.20 | +0.20 |
| potential | | | | | | | | | | |
| (V) | | | | | | | | | | |
| Resulting | Au\|Pt | Au\|GC | Au\|Pt | Au\|GC | Au\|Pt | Au\|GC | Au\|Pt | Au\|GC | Au\|Pt | Au\|Pt |
| Gold- | | | | | | | | | | |
| bearing | | | | | | | | | | |
| substrate | | | | | | | | | | |

### Example 1 (E1)

Example 1 was realized with the gold-bearing substrate Au|Pt (substrate 1, Table 4). The deposition time used for this example was 35 minutes.

The gold-bearing substrate Au|Pt (substrate 1, Table 4) was immersed in the leaching liquid substance ChCl-Ox, containing 5 mmol/kg Au(III), during 2 h 15 min at 60° C. in a drying oven. After this treatment, no gold was visibly observed at the surface of the substrate, in other words, the gold leached out of the gold-bearing substrate into the liquid substance.

### Counter-Example 2 (CE2)

The Counter-Example 2 was realized in the same conditions than Example 1 except that the gold-bearing substrate Au|Pt (substrate 1, Table 4) was immersed in the liquid substance ChCl-Ox which does not contain any gold salt. In these conditions, metallic gold remained at the surface of the substrate. This observation demonstrates that no leaching out of gold occurs in absence of Au(III) ions.

### Example 3

Example 3 was realized with the gold-bearing substrate Au|Pt (substrate 1, Table 4) in the leaching liquid substance ChCl-Ox containing 10 mmol/kg Au(III) (Au(III)-ChCl-Ox herein after). Chronopotentiometric experiments were performed as detailed above.

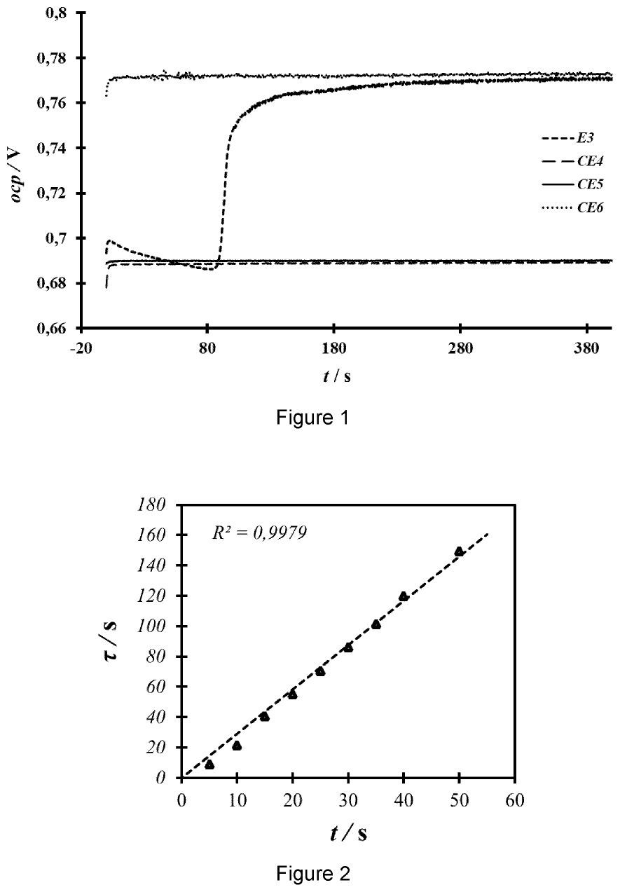

The ocp of the gold-bearing substrate Au|Pt in contact with the leaching liquid substance Au(III)-ChCl-Ox, was recorded as a function of time at 60° C. (FIG. 1, dash line E3). The experimental results as shown in FIG. 1 clearly demonstrate that the curve recorded at the gold-bearing substrate Au|Pt immersed in Au(III)-ChCl-Ox surprisingly exhibited at 85 s a marked jump of the ocp. This jump of the ocp is also called “time t”. Before this potential jump, the ocp was similar to that of the Au(I)/Au(0) couple, around +0.69 V. At longer times, the ocp tended to +0.77 V which is the ocp of a Pt substrate (without gold) in contact with Au(III)-ChCl-Ox.

This observation demonstrates that metallic gold, Au(0), initially present at the surface of the gold-bearing substrate Au|Pt was leached out by the leaching liquid substance. The potential jump at 85 s was the time at which all the metallic gold, Au(0) was leached out of the gold-bearing substrate.

Without being bound to this theory, this behavior can be explained by the fact that surprisingly a comproportionation reaction takes place at the surface of the gold-bearing substrate where Au(0) may interact with auric ions, Au(III) to form Au(I) in solution.

This reaction occurs as long as metallic gold is present at the surface of the gold-bearing substrate.

### Counter-Example 4 (CE4)

Counter-Example 4 was realized in the same conditions than Example 3 except that that Au(I) was used instead of Au(III).

The ocp of the gold-bearing substrate Au|Pt (substrate 1, Table 4) in contact with the liquid substance Au(I)-ChCl-Ox, was recorded as a function of time (FIG. 1, dash line CE4). The ocp was +0.69 V and was constant over time. This observation demonstrate that no reaction occurs at the surface of the substrate. This result shows that contrary to auric ions, Au(III), aurous ions, Au(I), do not contribute to the leaching of gold.

### Counter-Example 5 (CE5)

Counter-Example 5 was realized in the same conditions than Counter-Example 4 except that the substrate was only composed of Pt instead of the gold-bearing substrate Au|Pt.

The ocp of the substrate Pt in contact with the liquid substance Au(I)-ChCl-Ox was recorded as a function of time (FIG. 1, solid line CE5). The ocp was +0.69 V and was constant over time. This observation demonstrate that no reaction occurs at the surface of the substrate.

### Counter-Example 6 (CE6)

Counter-Example 6 was realized in the same conditions than Counter-Example 5 except that Au(III) was used instead of Au(I).

The ocp of the substrate Pt in contact with the leaching liquid substance Au(III)-ChCl-Ox was recorded as a function of time (FIG. 1, dash line CE6). The ocp was +0.77 V and was constant over time. This observation demonstrate that no reaction occurs at the surface of the substrate.

### Example 7

Example 7 was realized in the same conditions than Example 3 except that various deposition times were used for the preparation of the gold-bearing substrate.

The time τ, which corresponds to the jump of the ocp, was plotted on a chart as a function of the deposition time (FIG. 2). FIG. 2 demonstrates a linear relation (R²=0.9979) between the deposition time, which reflects the quantity of metallic gold at the surface of the gold-bearing substrate, and the time t.

The results in FIG. 2 show that irrespective the quantity of metallic gold present at the surface of the gold-bearing substrate, the leaching of gold occurs as long as metallic gold, Au(0), is in contact with the leaching liquid substance Au(III)-ChCl-Ox.

### Example 8

Example 8 was realized in the same conditions than Example 3 except that the gold-bearing substrate was Au|GC (substrate 2, Table 4) instead of Au|Pt (substrate 1, Table 4). Chronopotentiometric experiments were performed as detailed above.

The ocp of the gold-bearing substrate Au|GC in contact with the leaching liquid substance Au(III)-ChCl-Ox was recorded as a function of time. The experimental results clearly demonstrated that the curve recorded at the gold-bearing substrate Au|GC immersed in Au(III)-ChCl-Ox surprisingly exhibited at 370 s a marked jump of the ocp. After this potential jump, the ocp tended to +0.74 V which is the ocp of a GC substrate (without gold) in contact with Au(III)-ChCl-Ox.

This observation demonstrates that metallic gold, Au(0), initially present at the surface of the gold-bearing substrate Au|GC was leached out by the leaching liquid substance. The potential jump at 370 s was to the time at which all the metallic gold, Au(0), was leached out of the gold-bearing substrate.

### Counter-Example 9

Counter-Example 9 was realized in the same conditions than Example 8 except that that Au(I) was used instead of Au(III).

The ocp of the gold-bearing substrate Au|GC in contact with the liquid substance Au(I)-ChCl-Ox was recorded as a function of time. The ocp was +0.70 V and was constant over time. This observation demonstrated that no reaction occurs at the surface of the substrate. This result shows that contrary to auric ions, Au(III), aurous ions, Au(I), do not contribute to the leaching of gold.

### Counter-Example 10

Counter-Example 10 was realized in the same conditions than Counter-Example 9 except that the substrate was only composed of GC instead of the gold-bearing substrate Au|GC.

The ocp of the substrate GC in contact with the leaching liquid substance Au(I)-ChCl-Ox was recorded as a function of time. The ocp was +0.70 V and was constant over time. This observation demonstrated that no reaction occurs at the surface of the substrate.

### Counter-example 11

Counter-Example 11 was realized in the same conditions than Counter-Example 10 except that Au(III) was used instead of Au(I).

The ocp of the substrate GC in contact with the leaching liquid substance Au(III)-ChCl-Ox was recorded as a function of time. The ocp was +0.74 V and was constant over time. This observation demonstrated that no reaction occurred at the surface of the substrate.

### Example 12

Example 12 was realized in the same conditions than Example 8 except that various deposition time were used for the preparation of the gold-bearing substrate.

The time τ, which corresponds to the jump of the ocp, was plotted on a chart as a function of the deposition time. A linear relation (R²=0.9979) was obtained between the deposition time, which reflects the quantity of metallic gold at the surface of the gold-bearing substrate, and the time τ.

The results showed that irrespective the quantity of metallic gold present at the surface of the gold-bearing substrate, the leaching of gold occurs as long as metallic gold, Au(0), is in contact with the leaching liquid substance Au(III)-ChCl-Ox.

### Examples 13 to 16

Chronopotentiometric experiments were realized with different gold-bearing substrates (Table 4) in different leaching liquid substances, as detailed in Table 5.

Also, different deposition times were used for the preparation of the gold-bearing substrate, as detailed in Table 5. The concentration in Au(III) in the leaching liquid substance was of 10 mmol/kg.

The ocp of the gold-bearing substrate in contact with the leaching liquid substance was recorded as a function of time, for each of the systems tested.

For each of the systems, the time τ, which corresponds to the jump of the ocp, was identified and reported in Table 5 herein below as a function of the deposition time.

TABLE 5
Time τ versus deposition time in examples 13-16

| | 13 | 14 | 15c | 16 |
|---|---|---|---|---|
| | Leaching Liquid Substance | | | |
| | Au(III)-ChCl-Gly | Au(III)-ChCl-Gly | Au(III)-ChCl-Lev | Au(III)-ChCl-Lev |
| | Substrate (Table 4) | | | |
| | Au\|Pt | Au\|GC | Au\|Pt | Au\|GC |
| Deposition time | Substrate 3 | Substrate 4 | Substrate 5 | Substrate 6 |
| (in s) | Time τ (in s) | | | |
| 0 | 0 | 0 | 0 | 0 |
| 20 | 34 | 62 | 65 | 240 |
| 30 | 50 | 94 | 103 | 300 |
| 40 | 63 | 114 | 130 | 360 |
| 60 | 91 | 145 | 192 | 476 |
| 120 | 165 | 230 | 408 | 690 |

These results show that the leaching of gold occurs in different non-aqueous liquid substances and with the different gold-bearing substrates tested as long as the metallic gold is in contact with auric ions, Au(III).

### Counter-Example 17 (CE17)

Counter-Example 17 was realized with the gold-bearing substrate Au|Pt (substrate 7, Table 4) in the leaching liquid substance ChCl-U containing 10 mmol/kg Au(III) (Au(III)-ChCl-U herein after). Chronopotentiometric experiments were performed as detailed above at 60° C.

The ocp of the gold-bearing substrate Au|Pt in contact with the leaching liquid substance Au(III)-ChCl-U, was recorded as a function of time. The experimental results clearly demonstrate that the curve recorded at the gold-bearing substrate Au|Pt immersed in Au(III)-ChCl-U did not exhibit any jump of the ocp. The ocp was +0.63 V and was constant over time. This observation demonstrates that no reaction occurred at the surface of the substrate.

### Counter-Example 18 (CE18)

Counter-Example 18 was realized in the same conditions than CE17 except that that Au(I) was used instead of Au(III).

The ocp of the gold-bearing substrate Au|Pt (substrate 7, Table 4) in contact with the leaching liquid substance Au(I)-ChCl-U, was recorded as a function of time. The ocp was +0.63 V and was constant over time. This observation demonstrates that no reaction occurs at the surface of the substrate.

### Counter-example 19 (CE19)

Counter-Example 19 was realized in the same conditions than Counter-Example 18 except that the substrate was only composed of Pt instead of the gold-bearing substrate Au|Pt.

The ocp of the substrate Pt in contact with the leaching liquid substance Au(I)-ChCl-U was recorded as a function of time. The ocp was +0.63 V and was constant over time. This observation demonstrate that no reaction occurs at the surface of the substrate.

### Counter-Example 20 (CE20)

Counter-Example 20 was realized in the same conditions than Counter-Example 19 except that Au(III) was used instead of Au(I).

The ocp of the substrate Pt in contact with the leaching liquid substance Au(III)-ChCl-U was recorded as a function of time. The ocp was +0.63 V and was constant over time. This observation demonstrates that no reaction occurs at the surface of the substrate.

### Example 21 (E21)

Example 21 was realized with a gold-coated glass as gold-bearing substrate.

The gold-bearing substrate was immersed in the leaching liquid substance ChCl-EG, containing 10 mmol/kg Au(III), during 24 h at 60° C. After this treatment, no gold was anymore present at the surface of the substrate, in other words, the gold leached out of the gold-bearing substrate into the liquid substance.

### Example 22 (E22)

The Example 22 was realized in the same conditions than Example 21 except that the gold-bearing substrate was immersed in the leaching liquid substance ChCl-EG, containing 10 mmol/kg Au(III), during 24 h at 20° C. instead of 60° C. After this treatment, no gold was anymore present at the surface of the substrate, in other words, the gold leached out of the gold-bearing substrate into the liquid substance.

### Example 23 (E23)

The Example 23 was realized in the same conditions than Example 21 except that the gold-bearing substrate was immersed in the leaching liquid substance ChCl-Gly, containing 10 mmol/kg Au(III), instead of ChCl-EG. After this treatment, no gold was anymore present at the surface of the substrate, in other words, the gold leached out of the gold-bearing substrate into the liquid substance.

### Example 24 (E24)

Example 24 was realized with the gold-bearing substrate Au|Pt (substrate 9, Table 4) in the leaching liquid substance ChCl-EG containing 10 mmol/kg Au(III) (Au(III)-ChCl-EG herein after). The deposition time used for this example was 5 s.

Chronopotentiometric experiments were performed as detailed above.

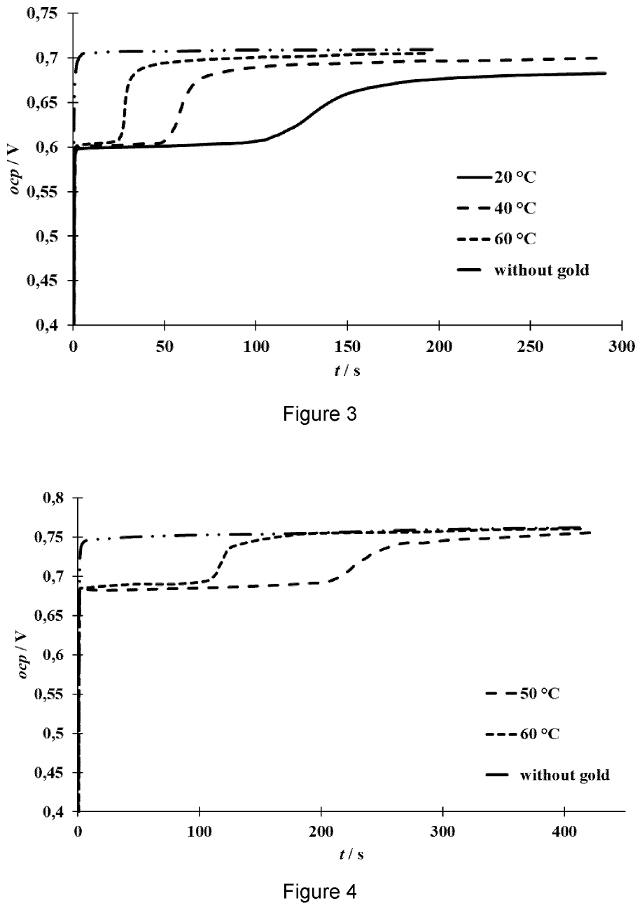

The ocp of the gold-bearing substrate Au|Pt in contact with the leaching liquid substance Au(III)-ChCl-EG, was recorded as a function of time at respectively 20° C., 40° C. and 60° C. The experimental results as shown in FIG. 3 clearly demonstrate that the curve recorded at the gold-bearing substrate Au|Pt immersed in Au(III)-ChCl-EG surprisingly exhibited at respectively 130 s, 60 s and 30 s a marked jump of the ocp. This jump of the ocp is also called “time t”. Before this potential jump, the ocp was similar to that of the Au(I)/Au(0) couple, around +0.60 V. At longer times, after the jump, the ocp tended to +0.70 V which is the ocp of a Pt substrate (without gold) in contact with Au(III)-ChCl-EG.

### Examples Using Aqueous Leaching Liquid Substances

Aqueous leaching liquid substances were prepared by admixing in demineralized water a chloride salt up to the limit of solubility and a Au(III) salt at a concentration of 10 mmol/kg.

The resulting mixtures were heated at 60° C. and maintained at 60° C. under magnetic stirring until the complete dissolution of the salts to obtain the aqueous leaching liquid substance.

The apparent pH of the leaching liquid substances was measured as described above.

TABLE 6
apparent pH of the aqueous leaching liquid substances

| | / | HAuCl₄ | AuCl₃ |
|---|---|---|---|
| KCl | +6.39 | +1.96 | +1.61 |
| NaCl | +5.88 | +0.64 | +2.80 |
| LiCl | +3.37 | −0.58 | +0.00 |
| ChCl | +6.66 | +1.90 | +2.84 |

The gold-bearing substrates were prepared in the same conditions than the gold-bearing substrates used in non-aqueous liquid substances except that the electrodeposition was performed in demineralized water containing a chloride salt, NaCl, up to the limit of solubility and a Au(III) salt at a concentration of 10 mmol/kg.

Alternatively, a gold-coated glass was used as gold-bearing substrate.

### Example 25

Different experiments were realized by immersing a gold-coated glass in different leaching liquid substances, as detailed in Table 7 during 24 h at 60° C.

Also, different Au(III) salts were used for the preparation of the aqueous leaching liquid substance, as detailed in Table 7. The concentration in Au(III) in the leaching liquid substance was of 10 mmol/kg.

After this treatment, for the majority of the leaching liquid substances tested, no gold was visibly observed at the surface of the substrate, in other words, the gold leached out of the gold-bearing substrate into the liquid substance. It is only for the aqueous leaching liquid substance containing NaCl and AuCl₃ that gold remained on the gold-bearing substrate. This means that in this aqueous leaching liquid substance, no reaction occurs at the surface of the substrate.

TABLE 7
aqueous leaching liquid substances

Au(III) ions

| Chloride salt | HAuCl₄ | AuCl₃ |
|---|---|---|
| KCl | No gold | No gold |
| NaCl | No gold | Gold |
| LiCl | No gold | No gold |
| ChCl | No gold | No gold |

### Example 26

Example 26 was realized with the a gold-bearing substrate Au|Pt (electrodeposition at +0.2 V during 5 s in NaCl+HAuCl₄ 10 mmol/kg) in the aqueous leaching liquid substance NaCl—HAuCl₄ in demineralized water. Chronopotentiometric experiments were performed as detailed above.

The ocp of the gold-bearing substrate Au|Pt in contact with the leaching liquid substance NaCl—HAuCl₄, was recorded as a function of time at respectively 50° C. and 60° C. The experimental results, as shown in FIG. 4, clearly demonstrate that the curve recorded surprisingly exhibited at respectively 220 s and 110 s a marked jump of the ocp. This jump of the ocp is also called “time τ”. Before this potential jump, the ocp was similar to that of the Au(I)/Au(0) couple, around +0.69 V. At longer times, after the jump, the ocp tended to +0.74 V which is the ocp of a Pt substrate (without gold) in contact with NaCl—HAuCl₄ in demineralized water.

1. A method for leaching gold from a gold-bearing substrate, the method including a step (a) of treating the gold-bearing substrate with at least one leaching liquid substance thereby generating at least one pregnant leaching liquid substance containing leached gold, the at least one leaching liquid substance comprising:
(i) at least one chloride salt; and
(ii) auric ions,
with the proviso that when the leaching liquid substance is a non-aqueous leaching liquid substance, the non-aqueous leaching liquid substance further comprises (iii) at least one hydrogen bond donor comprising at least one hydroxyl group.

2. The method according to claim 1 wherein auric ions are provided to the leaching liquid substance of at least an auric salt selected from the group consisting of AuCl₃, HAuCl₄, KAuCl₄, AuBr₃ and C₆H₉AuO₆.

3. The method according to claim 1 wherein the auric ions are present in the leaching liquid substance in a concentration from 0.5 mmol/kg to 20.0 mmol/kg, preferably from 1.0 mmol/kg to 15.0 mmol/kg, more preferably from 2.0 mmol/kg to 10.0 mmol/kg.

4. The method according to claim 1 wherein the at least one chloride salt is an inorganic chloride salt selected from the group consisting of sodium chloride, potassium chloride, lithium chloride, ammonium chloride, calcium chloride and magnesium chloride.

5. The method according to claim 1 wherein the at least one chloride salt is an organic chloride salt being a compound according to formula (V), 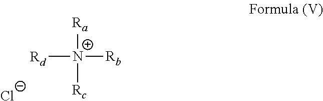
wherein each of Rₐ, R_{b}, R_{c}, and R_{d}, independently from each other are selected from C₁₋₄ alkyl or C₃₋₆ cycloalkyl, wherein said alkyl and cycloalkyl are optionally substituted with one or more substituents selected from the group consisting of OR₄₁, OC(═O)R₄₁, C(—O)OR₄₁, C(—O)R₄₁ or phenyl, wherein said R₄₁ is, independently from each other, selected from the group consisting of hydrogen, halo or C₁₋₄ alkyl.

6. The method according to claim 5 wherein the organic chloride salt is a quaternary ammonium chloride, preferably, the quaternary ammonium chloride is selected from the group consisting of (2-hydroxyethyl)trimethylammonium chloride (i.e. choline chloride); ethyl(2-hydroxyethyl)dimethylammonium chloride; Ethanaminium, 2-[(chlorocarbonyl)oxy]-N,N,N-trimethyl-, chloride; 2-hydroxyethyl(trimethyl)azanium, carbonochloridate, chloride; benzyl (2-hydroxyethyl)dimethylammonium chloride, or any combination thereof, more preferably, the organic chloride salt is (2-hydroxyethyl)trimethylammonium chloride.

7. The method according to claim 1 wherein the leaching liquid substance is an aqueous leaching liquid substance and the at least one chloride salt is present in the aqueous leaching liquid substance in a concentration from 1.0 mol/l to 6.0 mol/l, preferably from 2.0 mol/l to 5.0 mol/l, more preferably from 3.0 mol/l to 4.0 mol/l.

8. The method according to claim 1 wherein the leaching liquid substance is an non-aqueous leaching liquid substance and the at least one chloride salt is present in the non-aqueous leaching liquid substance in a concentration from 1.0 mol/kg to 15.0 mol/kg, more preferably from 2.0 mol/kg to 10.0 mol/kg, most preferably from 3.0 mol/kg to 5 mol/kg.

9. The method according to claim 8 wherein the at least one hydrogen bond donor is a compound chosen among those of formula (I) or (II), and isosorbide, fructose, and glucose, and stereoisomers thereof: 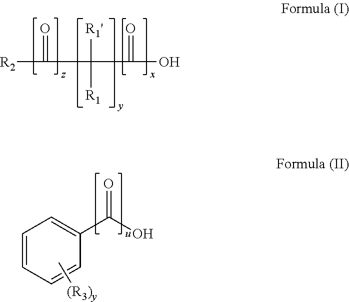
wherein:
x is an integer equal to 0 or 1;
each of R₁ and R₁′, independently from each other and at each occurrence, is selected from hydrogen or OR₁₂, wherein each of R₁₂ is hydrogen or a C₁₋₄ alkyl;
y is an integer in a range from 0 to 6;
z is an integer equal to 0 or 1;
R₂ is selected from the group consisting of hydrogen, a C₁₋₄ alkyl and OR₂₂, wherein R₂₂ is an hydrogen or a C₁₋₄ alkyl;
u is an integer equal to 0 or 1;
each of R₃ is selected from the group consisting of hydrogen, C₁₋₄ alkyl and C(═O)OR₃₁, wherein each of R₃₁ is hydrogen or C₁₋₄ alkyl; and
v is an integer in a range of 0 to 5.

10. The method according to claim 8 wherein at least one hydrogen bond donor is selected from the group consisting of glycerol, ethylene glycol, propylene glycol, acetic acid, levulinic acid, oxalic acid, mellitic acid, tartronic acid, tartaric acid, propionic acid, malonic acid, lactic acid, acetoacetic acid, succinic acid, benzoic acid, adipic acid, citric acid, phenol, o-cresol, xylenol, xylitol, sorbitol, isosorbide, fructose, glucose, or any combination thereof, more preferably the hydrogen bond donor is selected from the group consisting of glycerol, levulinic acid, oxalic acid, malonic acid, ethylene glycol, lactic acid.

11. The method according to claim 8 wherein the at least one chloride salt and the at least one hydrogen bond donor are first mixed to form a first liquid substance and wherein said first liquid substance is a deep eutectic mixture having a melting point lower than 100° C., preferably lower than 80° C., more preferably lower than 60° C.

12. The method according to claim 11 wherein the deep eutectic mixture is formed by intimate admixing at least one organic chloride salt being a quaternary ammonium chloride selected from the group consisting of (2-hydroxyethyl)trimethylammonium chloride (i.e. choline chloride); ethyl(2-hydroxyethyl)dimethylammonium chloride; Ethanaminium, 2-[(chlorocarbonyl)oxy]-N,N,N-trimethyl-, chloride; 2-hydroxyethyl(trimethyl)azanium, carbonochloridate, chloride; benzyl (2-hydroxyethyl)dimethylammonium chloride or any combination thereof, with at least one hydrogen bond donor selected from the group consisting of glycerol, ethylene glycol, acetic acid, levulinic acid, oxalic acid, mellitic acid, tartronic acid, tartaric acid, propionic acid, malonic acid, lactic acid, acetoacetic acid, succinic acid, benzoic acid, adipic acid, succinic acid, citric acid, phenol, o-cresol, xylenol, xylitol, sorbitol, isosorbide, fructose, glucose, or any combination thereof.

13. The method according to claim 1 further comprising the following step:
step (b): subjecting the at least one pregnant leaching liquid substance obtained in step (a) to an electrodeposition process thereby collecting at an cathode at least part of the leached gold while forming at an anode auric ions which remain in the resulting leaching liquid substance.

14. The method according to claim 13 further comprising the following step:
step (c): adding to step (a) at least part of the resulting leaching liquid substance obtained in step (b).

15. A leaching liquid substance comprising:
(i) at least one chloride salt; and
(ii) auric ions,
with the proviso that when the leaching liquid substance is a non-aqueous leaching liquid substance, the non-aqueous leaching liquid substance further comprises (iii) at least one hydrogen bond donor comprising at least one hydroxyl group.

16. A use of a leaching liquid substance for leaching gold, wherein the leaching liquid substance comprises:
(i) at least one chloride salt; and
(ii) auric ions,
with the proviso that when the leaching liquid substance is a non-aqueous leaching liquid substance, the non-aqueous leaching liquid substance further comprises (iii) at least one hydrogen bond donor comprising at least one hydroxyl group.

17. The method according to claim 2 wherein the auric ions are present in the leaching liquid substance in a concentration from 0.5 mmol/kg to 20.0 mmol/kg, preferably from 1.0 mmol/kg to 15.0 mmol/kg, more preferably from 2.0 mmol/kg to 10.0 mmol/kg.

18. The method according to claim 9 wherein at least one hydrogen bond donor is selected from the group consisting of glycerol, ethylene glycol, propylene glycol, acetic acid, levulinic acid, oxalic acid, mellitic acid, tartronic acid, tartaric acid, propionic acid, malonic acid, lactic acid, acetoacetic acid, succinic acid, benzoic acid, adipic acid, citric acid, phenol, o-cresol, xylenol, xylitol, sorbitol, isosorbide, fructose, glucose, or any combination thereof, more preferably the hydrogen bond donor is selected from the group consisting of glycerol, levulinic acid, oxalic acid, malonic acid, ethylene glycol, lactic acid.

19. The method according to any one of claim 9 wherein the at least one chloride salt and the at least one hydrogen bond donor are first mixed to form a first liquid substance and wherein said first liquid substance is a deep eutectic mixture having a melting point lower than 100° C., preferably lower than 80° C., more preferably lower than 60° C.
